(19) United States
(12) Patent Application Publication
(10) Pub. No.: US 2012/0050047 A1
(43) Pub. Date: Mar. 1, 2012

(54) TERMINAL AND SERVER FOR INTEGRATEDLY MANAGING PHD STANDARD AND PHD NON-STANDARD DATA

(75) Inventors: Jun-Hyung KIM, Suwon-si (KR); Jong-Hyo Lee, Pyeongtaek-si (KR); Joo-Yeol Lee, Seongnam-si (KR)

(73) Assignee: Samsung Electronics Co., Ltd., Suwon-si (KR)

(21) Appl. No.: 13/216,754

(22) Filed: Aug. 24, 2011

(30) Foreign Application Priority Data
Aug. 24, 2010 (KR) 10-2010-0081880

(51) Int. Cl. G08B 23/00

(52) U.S. Cl. 340/573.1

(57) ABSTRACT

A method, a terminal, and a server for integratedly managing Personal Health Device (PHD) standard and PHD non-standard data are provided. The terminal includes a first sensor for sensing a biological signal, and outputting PHD standard data that is in accordance with predetermined PHD standards; at least one second sensor for sensing a biological signal, and outputting PHD non-standard data that is not in accordance with the predetermined PHD standards; a controller for generating a first data field area based on the PHD standard data, generating a second data field area based on the PHD non-standard data, and then generating a transmission signal including the generated first data field area and the generated second data field area; and a communication unit for receiving the transmission signal from the controller, and transmitting the received transmission signal.

### PRIORITY

This application claims priority under 35 U.S.C. §119(a) to a Korean Patent Application entitled “Terminal and Server for Integratedly Managing PHD Standard and PHD Non-standard Data” filed in the Korean Intellectual Property Office on Aug. 24, 2010 and assigned Serial No. 10-2010-0081880, the entire contents of which are incorporated herein by reference.

### BACKGROUND OF THE INVENTION

1. Field of the Invention

The present invention relates generally to managing Personal Health Device (PHD) data, and more specifically, to a method for integratedly managing Personal Health Device (PHD) standard and PHD non-standard data and a terminal and server for implementing the method.

2. Description of the Related Art

Recently, populations of various regions around the world have been rapidly aging. Accordingly, social costs for senior health care are rapidly increasing and management costs corresponding to an increase in adult obesity patients are also increasing.

Due to an increase in medical costs associated with the above trends and increasing interests personal health, some medical services have changed from treatment-oriented services into prevention and diagnosis-oriented services. Also, due to increasing demand of consumers for excellent medical service, fusion and integration of Information Technology (IT) and medical prevention and diagnostic services are in actively progressing.

The Institute of Electrical and Electronics Engineers (IEEE) 11073 standards have been introduced in order to unify technology standards together in order to address the above-described trends, and accordingly, Personal Health Device (PHD) standards have been enacted. The PHD standards relate to specifications of health devices including a blood pressure monitor, weight scale, a blood glucose monitor, an electrocardiogram monitor, etc.

However, certain additional information other than health information prescribed by the IEEE 11073 standards (e.g., information indicating whether an exercise has been performed while a blood glucose level is measured) may also an important element in understanding a health condition of a consumer such as a patient. Accordingly, there is a need for integrated management of information other than information defined by the PHD standards.

However, conventional PHD devices are manufactured with an intent to merely satisfy PHD standards, and therefore, there conventional PHD devices cannot integratedly manage PHD standard data and PHD data that does not conform to PHD standards (hereinafter, “PHD non-standard data”).

### SUMMARY OF THE INVENTION

Accordingly, the present invention has been made to solve the above-mentioned problems occurring in the prior art, and an aspect of the present invention provides a terminal and a server that can integratedly manage PHD standard and PHD non-standard data.

In accordance with an aspect of the present invention, a terminal is provided. The terminal includes a first sensor for sensing a biological signal, and outputting Personal Health Device (PHD) standard data that is in accordance with predetermined PHD standards; at least one second sensor for sensing a biological signal, and outputting PHD non-standard data that is not in accordance with the predetermined PHD standards; a controller for generating a first data field area based on the PHD standard data, generating a second data field area based on the PHD non-standard data, and generating a transmission signal including the generated first data field area and the generated second data field area; and a communication unit for receiving the transmission signal from the controller, and transmitting the received transmission signal.

In accordance with another aspect of the present invention, a terminal is provided. The terminal includes an interface unit for receiving personal health device (PHD) standard data that is in accordance with predetermined PHD standards, and PHD non-standard data that is not in accordance with the predetermined PHD standards; a controller for generating a first data field area based on the PHD standard data, generating a second data field area based on the PHD non-standard data, and then generating a transmission signal including the first data field area and the second data field area; and a communication unit for receiving the transmission signal from the controller, and transmitting the received transmission signal.

In accordance with another aspect of the present invention, a terminal is provided. The terminal includes a first sensor for sensing a biological signal, and outputting Personal Health Device (PHD) standard data that is in accordance with predetermined PHD standards; at least one second sensor for sensing a biological signal, and outputting PHD non-standard data that is not in accordance with the predetermined PHD standards; a controller for extracting synchronization information performing for synchronization between the PHD standard data and the PHD non-standard data from the PHD standard data, generating a first data field area based on the synchronization information, generating a second data field area based on the PHD non-standard data, and then generating a transmission signal including the generated first data field area and the generated second data field area; and a communication unit for transmitting the PHD standard data and the transmission signal.

In accordance with another aspect of the present invention, a server is provided. The server includes a communication unit for receiving Personal Health Device (PHD) standard data and a transmission signal including a first data field area that is based on synchronization information for synchronization between the PHD standard data, which is in accordance with predetermined PHD standards, and PHD non-standard data, which is not in accordance with the predetermined PHD standards, and a second data field area that is based on the PHD non-standard data; a controller for synchronizing the PHD standard data with the PHD non-standard data based on the synchronization information extracted from the transmission signal; and an output unit for outputting pairs of the synchronized PHD standard data and PHD non-standard data.

In accordance with another aspect of the present invention, a terminal is provided. The terminal includes an interface unit for receiving PHD standard data, which is in accordance with predetermined Personal Health Device (PHD) standards, and PHD non-standard data, which is not in accordance with the predetermined PHD standards; a controller for extracting synchronization information for performing synchronization between the PHD standard data and the PHD non-standard data from the PHD standard data, generating a first data field area based on the synchronization information, generating a second data field area based on the PHD non-standard data, and then generating a transmission signal including the generated first data field area and the generated second data field area; and a communication unit for transmitting the PHD standard data and the transmission signal.

In accordance with another aspect of the present invention, a method for controlling a terminal is provided. The method includes receiving personal health device (PHD) standard data, which is in accordance with predetermined PHD standards, and PHD non-standard data that is not in accordance with the predetermined PHD standards; and generating a first data field area based on the PHD standard data, generating a second data field area based on the PHD non-standard data, and then generating a transmission signal including the generated first data field area and the generated second data field area.

In accordance with another aspect of the present invention, a method for controlling a terminal is provided. The method includes receiving Personal Health Device (PHD) standard data that is in accordance with predetermined PHD standards, and PHD non-standard data that is not in accordance with the predetermined PHD standards; extracting synchronization information for performing synchronization between the PHD standard data and the PHD non-standard data; and generating a first data field area based on the synchronization information, generating a second data field area based on the PHD non-standard data, and then generating a transmission signal including the generated first data field area and the generated second data field area.

In accordance with another aspect of the present invention, a method for controlling a server is provided. The method includes receiving Personal Health Device (PHD) standard data and a transmission signal including a first data field area, such that the first data field area is based on synchronization information for synchronization between the PHD standard data that is in accordance with predetermined PHD standards and receiving PHD non-standard data that is not in accordance with the predetermined PHD standards, and a second data field area, that that the second data field area is based on the PHD non-standard data; synchronizing the PHD standard data with the PHD non-standard data based on the synchronization information extracted from the transmission signal; and outputting pairs of the synchronized PHD standard data and PHD non-standard data.

### BRIEF DESCRIPTION OF THE DRAWINGS

The above and other features, aspects, and advantages of the present invention will be more apparent from the following detailed description taken in conjunction with the accompanying drawings, in which:

FIG. 1 is a diagram illustrating a system for integratedly managing PHD standard and PHD non-standard data according to an embodiment of the present invention;

FIG. 2A is a block diagram illustrating the configuration of a terminal according to an embodiment of the present invention;

FIG. 2B is a block diagram illustrating the configuration of a terminal according to another embodiment of the present invention;

FIG. 3 is a block diagram illustrating the configuration of a terminal according to another embodiment of the present invention;

FIG. 4 is a diagram illustrating a data field of a transmission signal according to an embodiment of the present invention;

FIG. 5 is a signal flow diagram illustrating a system including a terminal and a server according to another embodiment of the present invention;

FIG. 6 is a block diagram illustrating the configuration of a system including a terminal and a server according to another embodiment of the present invention;

FIG. 7 is a block diagram illustrating the configuration of a system according to another embodiment of the present invention;

FIG. 8 is a conceptual view illustrating a data field of a transmission signal according to an embodiment of the present invention; and

FIG. 9 is a signal flow diagram illustrating a system including a terminal and a server according to another embodiment of the present invention.

### DETAILED DESCRIPTION OF THE EMBODIMENTS OF THE INVENTION

Hereinafter, embodiments of the present invention are described in detail with reference to the accompanying drawings. In the accompanying drawings, the same or similar elements are designated by the same reference numerals throughout the following description and drawings, even when shown in different drawings. A detailed description of publicly-known functions and configurations, which may unnecessarily obscure the subject matter of the present invention, are omitted in the following description and the accompanying drawings for clarity and conciseness.

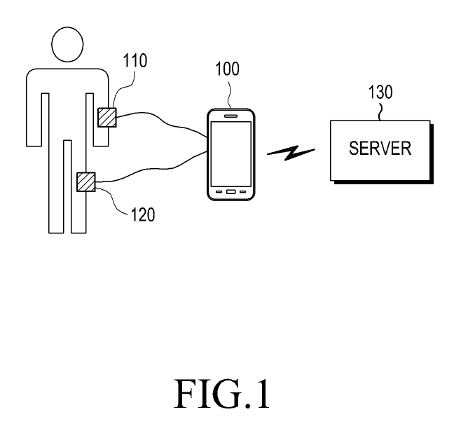

FIG. 1 is a diagram illustrating a system for integratedly managing PHD standard and PHD non-standard data according to an embodiment of the present invention.

Referring FIG. 1, a system for integratedly managing PHD standard and PHD non-standard data according to an embodiment of the present invention includes a terminal 100 and a server 130. The terminal 100 includes a first sensor 110 and a second sensor 120.

The first sensor 110 senses a biological signal output from a user, and outputs PHD standard data corresponding to the sensed biological signal. In the present example, PHD standard data may be data in a format defined by the IEEE 11073 standards. The IEEE 11073 standards define personal health-related data. The first sensor 110 may be implemented by using a service component, a Personal Area Network (PAN) apparatus, a sensor for sensing a biological signal, etc. Although the present example specifically refers to IEEE 11703 standards, this example is non-limiting, and PHD standard data in accordance with other embodiments of the present invention may include data in accordance with another predetermined PHD standard.

The first sensor 110 transmits/receives data to/from the terminal 100 connected thereto through a wired/wireless connection, such as a Universal Serial Bus (USB) connection, a Bluetooth connection, a Personal Area Network (PAN) connection, etc.

The first sensor 110 senses and collects data defined by the IEEE 11073 standards (i.e. the PHD standards). For example, the first sensor 110 may sense and collect data in the following three PHD standards fields:
the first PHD standard field: a disease management field;
the second PHD standard field: a health and fitness-related field; and
the third PHD standard field: an independent living field.

The first sensor 110 according to the first field (i.e., the disease management field) may be implemented by using a pulse oximeter, a heart rate monitor, a blood pressure monitor, a thermometer, a weighing scale, and/or a blood glucose monitor.

The first sensor 110 according to the second field (i.e., the health and fitness-related field) may be implemented by using a cardiovascular fitness and activity monitor, and/or strength fitness equipment.

The first sensor 110 according to the third field (i.e., the independent living field) may be implemented by using a disease management device, an independent living activity hub, and/or a medication monitor.

The first sensor 110 may sense or receive, as input, various biological signal data or user condition-related data defined by the PHD standards as described above.

The second sensor 120 may sense or receive, as input, data that is not defined by the PHD standards from a user.

The second sensor 120, for example, may sense or receive as an input at least one of information indicating a type of the second sensor 120, a type of PHD non-standard data, and information indicating a measurement time and a measured value of the PHD non-standard data. In this case, the term “PHD non-standard data” refers to data that is not defined by PHD standards, and for example, may be information indicating the amount of exercise of a user, whether blood pressure medicine has been administered, and the condition of a patient.

For example, when the PHD standard data is related to a heart rate, the amount of exercise of a user may be an important element in determining whether a heart rate of the user is normal. Accordingly, the terminal 100 may integratedly manage a heart rate as the PHD standard data and the amount of exercise of the user as the PHD non-standard data. Meanwhile, the examples of the PHD non-standard data as described above are merely provided as non-limiting of the second sensor 120. Therefore, those skilled in the art will easily be able to understand that other PHD non-standard measurement apparatuses related to the health of a user or means capable of receiving input information regarding the health of a user may be used in accordance with embodiments of the present invention.

The second sensor 120 outputs sensed and/or input data to the terminal 100 by using a predetermined communication means such as a USB connection, Bluetooth connection, PAN connection, etc.

The terminal 100 receives, as input, PHD standard data from the first sensor 110, and PHD non-standard data from the second sensor 120. The terminal 100 generates a first data field area based on the received PHD standard data, and generates a second data field area based on the PHD non-standard data. Then, the terminal 100 may generate a transmission signal including the first and second data field areas. such a transmission signal is described herein below in more detail with reference to FIG. 4.

The terminal 100 may generate a transmission signal including the PHD standard data and the PHD non-standard data, and then transmit the generated transmission signal to the server 130.

The server 130 separates PHD standard data and PHD non-standard data from the received transmission signal, and manages the separated PHD standard data and PHD non-standard data. The server 130 may store or output pairs of the PHD standard data and the PHD non-standard data.

As described above, a means for sensing or inputting biological information that does not meet the PHD standards may be used in connection with a means for sensing or inputting biological information that meets the PHD standards.

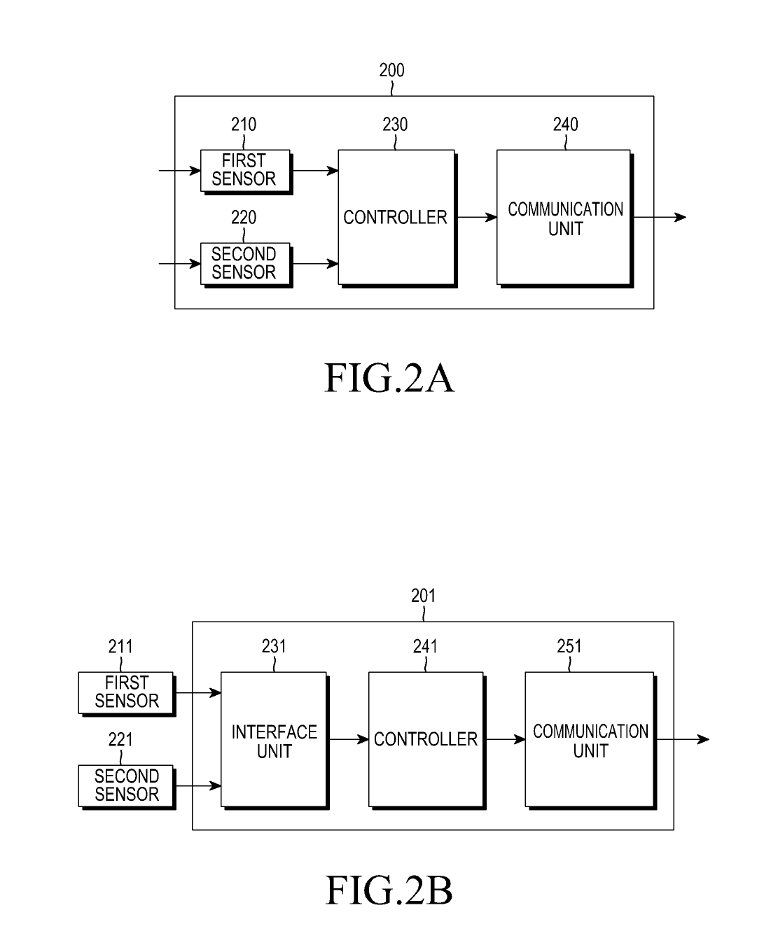

FIG. 2A is a block diagram illustrating a configuration of a terminal according to an embodiment of the present invention.

Referring FIG. 2A, a terminal 200 includes a first sensor 210, a second sensor 220, a controller 230, and a communication unit 240. The first sensor 210 senses or receives, as input, PHD standard data. The first sensor 210 operates in a manner similar to the first sensor 110 described above in detail with reference to FIG. 1, and therefore, a more detailed description of the first sensor 210 is omitted for clarity and conciseness.

The second sensor 220 senses or receives, as input, PHD non-standard data. The second sensor 220 operates in a manner similar to the second sensor 120 described above in detail with reference to FIG. 1, and therefore, a more detailed description of the second sensor 220 is omitted for clarity and conciseness.

The first and second sensors 210 and 220 may be physically included within the terminal 200. For example, when the first sensor 210 is a blood glucose level monitor, a means capable of measuring a blood glucose level may be included in the terminal itself. When the second sensor 220 is a means for measuring the amount of exercise of a user, for example, the means for measuring the amount of exercise of a user may be included within the terminal.

The controller 230 generates a first data field area based on PHD standard data, and generates a second data field area based on PHD non-standard data. The controller 230 may also generate a transmission signal including the first and second data field areas. In this case, the transmission signal may additionally include a Media Access Control (MAC) header field area including header information, as well as the first and second data field areas. The transmission signal may be based on any standard scheme. For example, the transmission signal may configure a data field area based on standards other than the IEEE 11073 standards. For example, the transmission signal may include a MAC header field area, a data field area corresponding to PHD standard data, and a data field area corresponding to PHD non-standard data. In this case, a data field area corresponding to PHD non-standard data may be named “additional information field.” The controller 230 may be implemented by using a microprocessor, a minicomputer, or another such device, which may perform a calculation process and generate the above data field area.

The communication unit 240 transmits the transmission signal received from the controller 230 to an entity external to the terminal 200. The communication unit 240 may transmit the transmission signal according to a communication standard in which the transmission signal has been generated. The communication unit 240 may perform communication in at least one scheme among Wireless-Fidelity (Wi-Fi), Long Term Evolution (LTE), 3^{rd} Generation Partnership Project 2 (3GPP2), 3rd Generation Partnership Project (3GPP), Worldwide Interoperability for Microwave Access (WiMAX), and IEEE 802.16m, for example. However, these examples of communication schemes are non-limiting, and other wired/wireless communication schemes may be used in accordance with embodiments of the present invention.

The communication unit 240 performs transmission/reception of a transmission signal. Accordingly, the communication unit 240 may include a Radio Frequency (RF) transmitter for upconverting the frequency of a transmission signal to be transmitted and then amplifying the frequency-upconverted signal, an RF receiver for low-noise amplifying a received signal and then downconverting the frequency of the low-noise amplified signal, an antenna for transmission/reception, etc.

FIG. 2B is a block diagram illustrating a configuration of a terminal according to another embodiment of the present invention.

As illustrated in FIG. 2B, the terminal 201 may include an interface unit 231, a controller 241, and a communication unit 251. The interface unit 231 may be connected to a first sensor 211 and a second sensor 221.

In contrast to the terminal illustrated in FIG. 2A, the terminal illustrated in FIG. 2B does not include the first sensor 211 and the second sensor 221 within the terminal 201 itself, but includes the interface unit 231 for inputting/outputting data to/from the first sensor 211 and the second sensor 221.

The first sensor 211 may sense or receive, as input, PHD standard data in the same manner as that of the first sensor 210 illustrated in FIG. 2A. The second sensor 221 may sense or receive, as input, PHD standard data in the same manner as that of the second sensor 220 illustrated in FIG. 2A. The first sensor 211 and the second sensor 221 may be wiredly or wirelessly connected to the interface unit 231. The first sensor 211 and second sensor 221 may include a connection means connected to a USB terminal, for example, and the interface unit 231 may include a USB terminal corresponding to the connection means. The interface unit 231 may receive as an input PHD standard data from the first sensor 211 and PHD non-standard data from the second sensor 221 through a USB parallel port.

As another example in accordance with embodiments of the present invention, the first sensor 211 and second sensor 221 may additionally include a wireless communication means. For example, the first sensor 211 and second sensor 221 may additionally include, but are not limited to, an infrared communication means, a visible light communication means, a Wi-Fi communication means, a Blue-tooth communication means, and/or an NFC (Near Field Communication) communication means, for example. The interface unit 231 may similarly include, but is not limited to, an infrared communication means, a visible light communication means, a Wi-Fi communication means, a Blue-tooth communication means, and/or an NFC communication means, for example. Accordingly, the first sensor 211 and the second sensor 221 may transmit/receive data to/from the interface unit 231 in a wireless communication scheme. Meanwhile, various wired/wireless communication schemes other than those described above may be utilized in accordance with embodiments of the present invention.

As illustrated in FIGS. 2A and 2B, the terminal may include the first sensor and the second sensor therewithin, or may be wiredly or wirelessly connected to the first sensor and the second sensor and then may use them. Also, those skilled in the art can easily understand that either one of the first sensor and the second sensor may be included in the terminal, while the other sensor may be wiredly/wirelessly connected to the terminal, and varying numbers of first and second sensors may be used with a terminal in accordance with embodiments of the present invention.

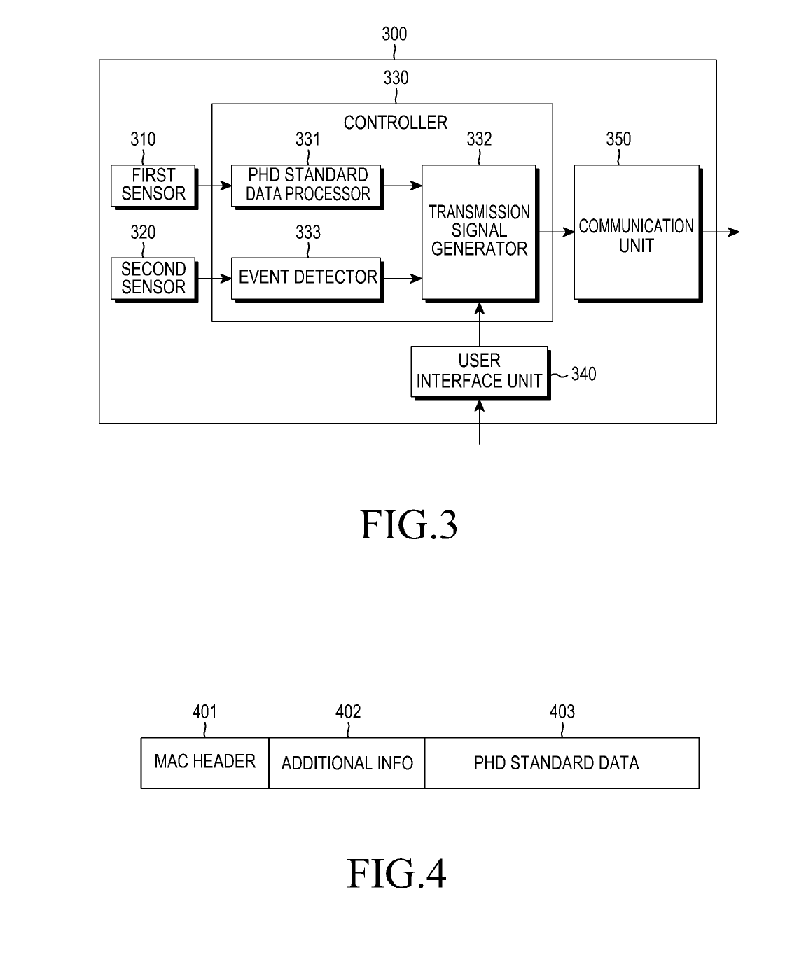

FIG. 3 is a block diagram illustrating a configuration of a terminal according to another embodiment of the present invention.

Referring to FIG. 3, a terminal 300 includes a first sensor 310 and a second sensor 320, a controller 330, a user interface unit 340, and a communication unit 350. The controller 330 includes a PHD standard data processor 331, a transmission signal generator 332, and an event detector 333. Meanwhile, the first and second sensors 310 and 320 and the communication unit 350 in FIG. 3 are similar to corresponding elements described with reference to FIGS. 1, 2A, and 2B, and therefore the function of these elements illustrated in FIG. 3 are omitted or only briefly described for clarity and conciseness.

The PHD standard data processor 331 extracts information represented by PHD standard data received from the first sensor 310, and then converts the extracted information to information that meets a standard corresponding to a transmission signal. For example, the PHD standard data may be described in an OBject Exchange (OBEX) scheme, and the PHD standard data processor 331 may generate a first data field by extracting information from the PHD standard data in the OBEX scheme. The OBEX scheme is a communication protocol for exchanging binary objects between devices, and may be used in a binary scheme. The PHD standard data processor 331 may receive, as input, data transmitted in a binary scheme, and then convert the received data to data that meets a preset standard related to a transmission signal. The PHD standard data processor 331 converts PHD standard data into a data format defined by a predetermined preset standard by using a program such as a PHD message template, or more specifically, a PHD message builder.

The user interface unit 340 receives a user input signal, and outputs the received user input signal to a transmission signal generator 332. The user interface unit 340, which has a matrix structure (not shown), includes character keys, number keys, various function keys and an external volume key, and outputs a user input signal corresponding to a key pressed by a user to the transmission signal generator 332. The interface unit 340 may be a touch screen.

The user input signal may be a signal that the user directly inputs as according to a health condition of the user. For example, the user may directly input, to the user interface unit 340, the amount of time during which the user has exercised, burned calories, etc.

The transmission signal generator 332 may generate a first data field and a second data field for each of PHD standard data, which has been converted according to a preset standard related to a transmission signal received from the PHD standard data processor 331, and PHD non-standard data received from the second sensor 320. The transmission signal generator 332 may also generate a transmission signal including the first data field and the second data field. The transmission signal generator 332 may also merge the PHD non-standard data with the user input signal received from the user interface unit 340, and then generate a second data field. In this case, a form, in which the PHD non-standard data has been merged with the user input signal, may be named “additional information.” The transmission signal generator 332 may generate the transmission signal, in a packet form, including a data field, which is based on the preset standard.

The event detector 333 detects an event where the transmission signal has been generated. When such an event has been detected, the controller 330 may control the communication unit 340 to notify a server that the transmission signal has been generated.

FIG. 4 is a diagram illustrating a data field of a transmission signal according to an embodiment of the present invention.

Referring to FIG. 4, a transmission signal according to an embodiment of the present invention may include a MAC header field area 401, an additional information field area 402, and a PHD standard data field area 403. The MAC header field area 401 may include an addressing field or a source address field. The additional information field area 402 may include at least one of information of PHD non-standard data and information of a user input signal, as described above. For example, the second sensor senses calorie consumption according to the amount of exercise of the user, and the additional information field area 402 may include information on calorie consumption and the amount of time of exercise when the user inputs the amount of time of exercise as a user input signal.

The PHD standard data field area 403 includes information on PHD standard data that is sensed by the first sensor or is input.

Table 1 shows information stored in each data field area according to an embodiment of the present invention.

TABLE 1

| | additional information | PHD standard data field |
|---|---|---|
| MAC header field 401 | field 402 | 403 |
| 133.02.342.553. | the amount of time of | blood glucose level: |
| calorie consumption: | exercise: 1 □hour | 80 mg/dl |
| 150 kcal | | |

As described above, obtain information on a blood glucose level, for example, must be obtained from the PHD standard data. However, since the PHD non-standard data and the user input signal make it possible to understand a more accurate health condition of the user (e.g., in the present example, such that a blood glucose level is 80 mg/dl after an energy of 150 kcal is consumed for an amount of time of exercise equal to one hour), the addition of the non-standard information provides a noticeable effect on the usefulness of the information conveyed.

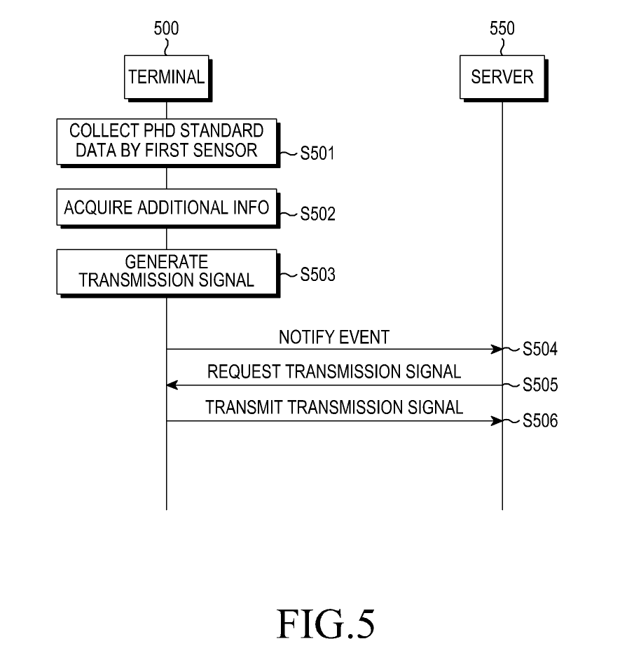

FIG. 5 is a signal flow diagram illustrating a system including a terminal and a server according to another embodiment of the present invention.

Referring to FIG. 5, a terminal 500 may directly or indirectly collect PHD standard data through a first sensor, in step S501. After collecting the PHD standard data, the terminal 500 acquires additional information, in step S502. As described above, the additional information may include at least one of PHD non-standard data that has been sensed or input via a second sensor or similar device, and a user input signal that has been input to an interface unit. Step S502 may be performed before, during, and/or after step S501.

After acquiring the PHD standard data and the additional information, the terminal 500 generates a transmission signal, which includes the PHD standard data and the additional information, according to a preset standard, in step S503.

The terminal 500 detects an event where the transmission signal has been generated, and notifies a server 550 that the transmission signal has been generated, in step S504. Upon being notified that the transmission signal has been generated, the server 550 requests transmission of the transmission signal, in step S505.

According to an alternative embodiment of the present invention, instead of being notified that the transmission signal has been generated, the server 550 may generate an inquiry packet, which periodically inquires whether the transmission signal has been generated, and then transmit the generated inquiry packet to the terminal 500. Upon receiving a response packet corresponding to the inquiry packet, the server 550 sends, to the terminal 500, a request to transmit the transmission signal. The server 550 may also periodically and unilaterally request transmission of the transmission signal.

When the terminal 500 has received the request for the transmission signal from the server 550, the terminal 500 transmits the generated transmission signal to the server 550, in step S506. However, the above-described sequence of operations is only provided as an example according to an embodiment of the present invention, and according to alternative embodiments of the present invention, the terminal 500 may immediately and unilaterally transmit the transmission signal to the server 550 whenever the terminal 500 detects an event where the transmission signal has been generated. Otherwise, after storing a transmission signal in an additionally included buffer for a predetermined time period, the terminal 500 may periodically transmit the transmission signal to the server 550.

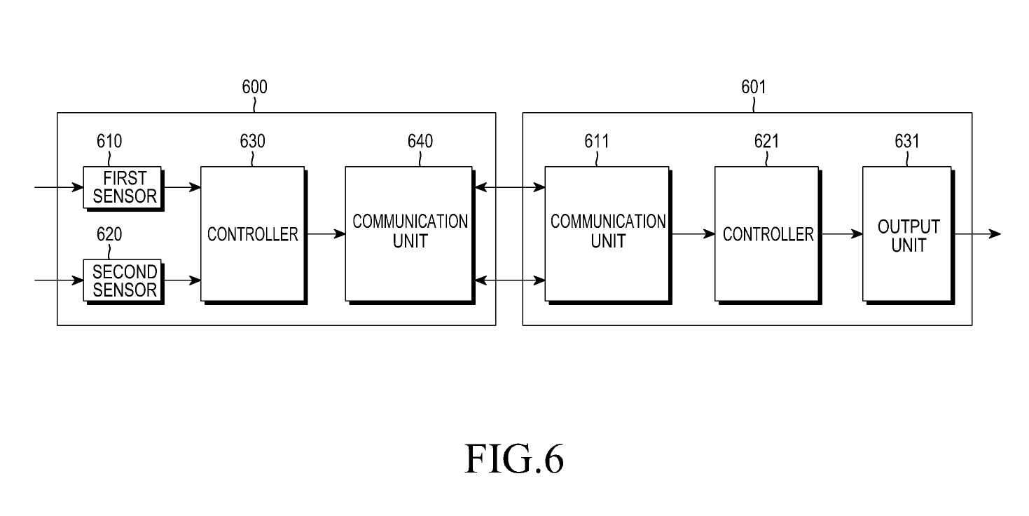

FIG. 6 is a block diagram illustrating the configuration of a system including a terminal and a server according to another embodiment of the present invention.

Referring to FIG. 6, a system may include a terminal 600 and a server 601. The terminal 600 may include a first sensor 610, a second sensor 620, a controller 630, and a communication unit 640. The server 601 includes a communication unit 611, a controller 621, and an output unit 631. Meanwhile, in order to distinguish between the elements of the terminal 600 and the server 601, the controller 630 and the communication unit 640 included in the terminal 600 are referred to as the “first controller 630” and the “first communication unit 640,” respectively, while the communication unit 611 and the controller 621 included in the server 601 are referred to as the “second communication unit 611” and the “second controller 621,” respectively.

The first sensor 610 and the second sensor 620 illustrated in FIG. 6 are identical to the first sensor 210 and the second sensor 220 illustrated in FIG. 2A, respectively. Therefore, a more detailed description of these elements with respect to FIG. 6 is omitted for clarity and conciseness. Although the first sensor 610 and the second sensor 620 are illustrated as being included within the terminal 600 in FIG. 6, this configuration is provided only as a non-limiting example according to an embodiment of the present invention. The first sensor 610 and the second sensor 620 may be implemented in such a form that they are physically separated from the terminal 600 and are wirelessly or wiredly connected to the terminal 600, such as illustrated in FIG. 2B.

The first controller 630 outputs the PHD standard data that has been input from the first sensor 610, to the first communication unit 640. The first communication unit 640 transmits the received PHD standard data to the second communication unit 611 according to a PHD standard communication scheme.

The first controller 630 receives, as input, PHD non-standard data from the second sensor 620. The first controller 630 extracts synchronization information from the PHD standard data. In this case, the synchronization information may be information corresponding to synchronization between the PHD standard data and the PHD non-standard data. Namely, the synchronization information may be information indicating whether PHD standard data and PHD non-standard data have been simultaneously measured. The simultaneously generated PHD standard data and PHD non-standard data may be managed in pairs based on the synchronization information. The synchronization information, for example, may be at least one of a time stamp and a session identification included in the PHD standard data.

The first controller 630 processes the PHD non-standard data and generates a transmission signal based on the synchronization information extracted from the PHD standard data. More specifically, the first controller 630 generates a first data field based on the extracted synchronization information, generates a second data field based on the PHD non-standard data, and generates a transmission signal including the first and second data fields. Meanwhile, the transmission signal may additionally include a MAC header field, etc. The transmission signal may be generated based on a preset transmission standard.

The first controller 630 outputs the generated transmission signal to the communication unit 640, and the first communication unit 640 outputs the transmission signal to the second communication unit 611 based on the preset standard. The first communication unit 640 transmits the received PHD standard data and the transmission signal to the second communication unit 611. Although the first communication unit 640 may time-divisionally transmit the PHD standard data and the transmission signal, this configuration is only provided as an example according to a non-limiting embodiment of the present invention, and another form of division may be used in accordance with embodiments of the present invention. For example, the first communication unit 640 may include two separate communication modules and simultaneously transmit the PHD standard data and the transmission signal.

The second communication unit 611 receives the PHD standard data and the transmission signal transmitted by the first communication unit 640. Although the second communication unit 611 may also time-divisionally receive the transmitted PHD standard data and transmission signal, this configuration is provided only as a non-limiting example according to an embodiment of the present invention, and other forms of division may be used in accordance with embodiments of the present invention. For example, the second communication unit 611 may include two separate communication modules, and may simultaneously receive the transmitted PHD standard data and transmission signal. The second communication unit 611 outputs the received PHD standard data and transmission signal to the controller 621.

The second controller 621 processes the received PHD standard data, and then converts the processed PHD standard data into data that meets a predetermined standard. For example, the second controller 621 may convert PHD standard data in a binary format, which is based on the OBEX scheme, into data that meets a predetermined standard, by using a program such as a PHD message template, or more specifically, a PHD message builder.

The second controller 621 extracts synchronization information from the received transmission signal. The second controller 621 may compare the synchronization information extracted from the transmission signal, with synchronization information of the PHD standard data, and then synchronize the transmission signal with respect to the PHD standard data. For example, the second controller 621 may use a time stamp as the synchronization information, and may compare a time stamp of the PHD standard data with a time stamp included in the transmission signal and then synchronize the PHD standard data, which includes an identical time stamp, with respect to the transmission signal including the identical time stamp. Therefore, the second controller 621 may manage, in pairs, the PHD standard data and the transmission signal, each of which includes the identical time stamp. Otherwise, the second controller 621 may cause the PHD standard data to correspond to additional information, which has been extracted from the transmission signal, and then manage, in pairs, the PHD standard data and the additional information.

The second controller 621 may output pairs of PHD standard data and a transmission signal corresponding to the PHD standard data to the output unit 631, and then the output unit 631 may output the received PHD standard data and transmission signal. Alternatively, the output unit 631 may output the received PHD standard data and additional information. The output unit 631 may be implemented by a variety of different devices as a means for enabling audiovisual perception by a user, in accordance with embodiments of the present invention.

Meanwhile, the controller 621 may further include a storage unit (not shown), and control the storage unit to store a pair of PHD standard data and a transmission signal or a pair of PHD standard data and additional information in the storage. When the controller 621 receives a request to read a pair of PHD standard data and a transmission signal or a pair of PHD standard data and additional information through the storage unit, the controller 621 may read and then output the pair of the PHD standard data and the transmission signal or the pair of the PHD standard data and the additional information.

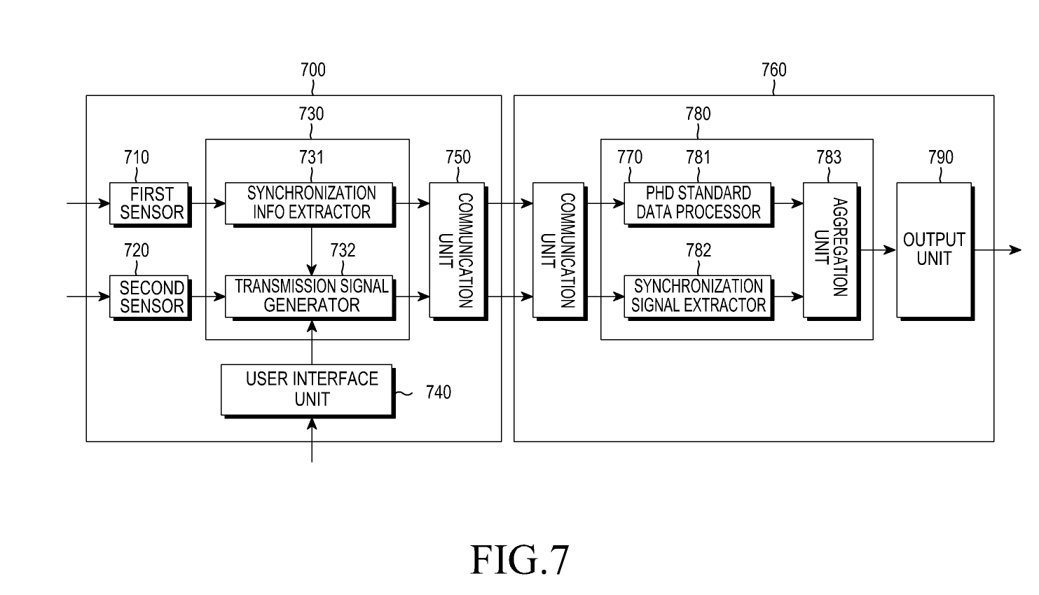

FIG. 7 is a block diagram illustrating the configuration of a system according to another embodiment of the present invention.

Referring to FIG. 7, a system according to an embodiment of the present invention may include a terminal 700 and a server 760. The terminal 700 may include a first sensor 710, a second sensor 720, a controller 730, a user interface unit 740, and a communication unit 750. The server 760 may include a communication unit 770, a controller 780, and an output unit 790. Meanwhile, some elements illustrated in FIG. 7 are identical to corresponding elements described with reference to FIG. 6, and therefore a description of such elements with respect to FIG. 7 are brief or omitted entirely for clarity and conciseness. Also, in order to more easily distinguish between elements of the terminal 700 and the service 760, the controller 730 and the communication unit 740 included in the terminal 700 are referred to as the “first controller 730” and the “first communication unit 740,” respectively, while the communication unit 770 and the controller 780 included in the server 760 are referred to as the “second communication unit 770” and the “second controller 780,” respectively.

The first controller 730 includes a synchronization information extractor 731 and a transmission signal generator 732. The synchronization information extractor 731 extracts synchronization information from the PHD standard data, which has been received from the first sensor 710, and then outputs the extracted synchronization information to the transmission signal generator 732. According to the present example, the synchronization information may be a time stamp or a session identification, as described above with reference to FIG. 6. The synchronization information extractor 731 may interpret a binary signal from a particular time point of an OBEX type binary signal, and then identify a time stamp or a session identification. By using a program such as a PHD message template, more specifically, a PHD message builder, the synchronization information extractor 731 may extract synchronization information, such as a time stamp or a session identification, from the PHD standard data, and then convert the extracted synchronization information to information that meets a predetermined preset standard.

The transmission signal generator 732 generates a transmission signal based on the PHD non-standard data received from the second sensor 720, the user input signal received from the user interface unit 740, and the synchronization information received from the synchronization information extractor 731. More specifically, the user interface unit 740 generates a first data field area for the synchronization information, and generates a second data field area for at least one of the PHD non-standard data and the user input signal. The user interface unit 740 generates a transmission signal including the first and second data field areas, such that the transmission signal meets a predetermined preset transmission standard. The transmission signal may additionally include a data field area such as a MAC header field, as well as the first and second data field areas.

Meanwhile, the second controller 780 of the server 760 includes a PHD standard data processor 781, a synchronization signal extractor 782 and an aggregation unit 783. The PHD standard data processor 781 processes the received PHD standard data, and then convert the processed PHD standard data to data that meets a predetermined preset standard. The PHD standard data processor 781 converts PHD standard data into data that meets a predetermined preset standard, by using a program such as a PHD message template, more specifically, a PHD message builder.

The synchronization information extractor 782 extracts synchronization information with reference to the first data field area of the transmission signal, and simultaneously outputs the extracted synchronization information and the transmission signal to the aggregation unit 783.

The aggregation unit 783 compares synchronization information of the PHD standard data, which has been received from the PHD standard data processor 781 and has been converted according to a preset standard, with synchronization information of the transmission signal received from the synchronization information extractor 782. By the comparison, the aggregation unit 783 may synchronize the PHD standard data with the transmission signal, so that the PHD standard data and the transmission signal can be managed in pairs. The aggregation unit 783 may be implemented by using a publicly-known aggregator.

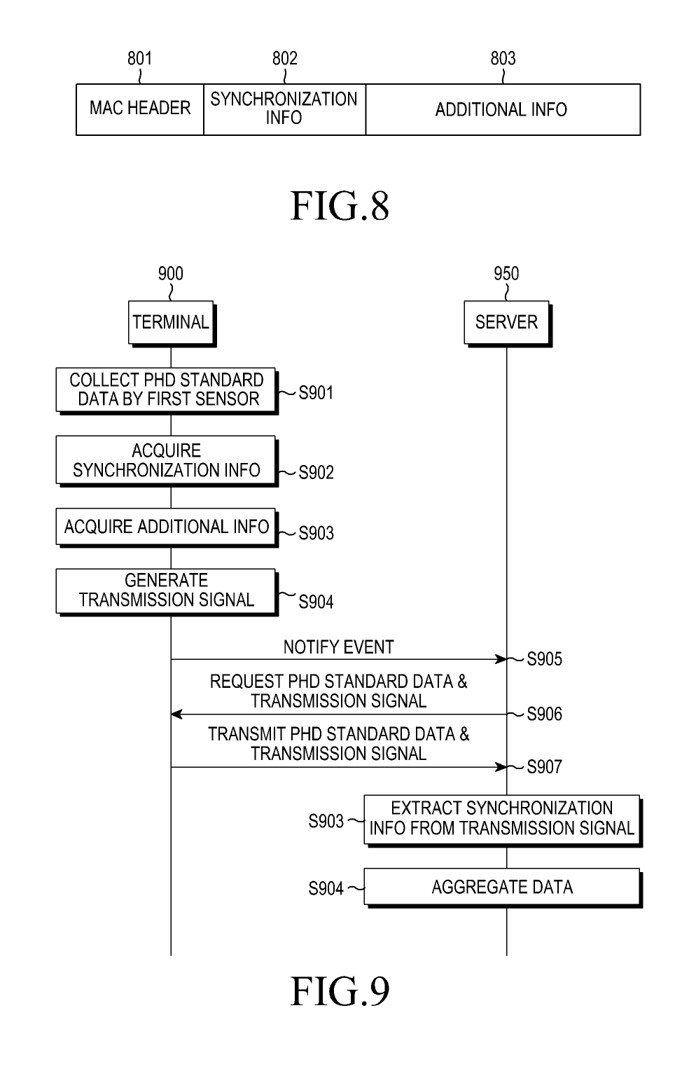

FIG. 8 is a conceptual diagram illustrating a data field of a transmission signal according to an embodiment of the present invention.

Referring to FIG. 8, a transmission signal according to an embodiment of the present invention may include a MAC header field area 801, a synchronization information field area 802, and an additional information field area 803.

The MAC header field area 801 may include an addressing field or a source address field. The synchronization information field area 802 includes synchronization information extracted from the PHD standard data, as described above. The additional information field area 803 includes at least one of information of PHD non-standard data and information of a user input signal. For example, when the second sensor senses calorie consumption according to the amount of exercise of a user and the user inputs the amount of time of exercise as a user input signal, the additional information field area 803 may include information on the calorie consumption and the amount of time of exercise.

Table 2 shows information stored in each data field area according to an embodiment of the present invention.

TABLE 2

| | synchronization | additional information |
|---|---|---|
| MAC header field 801 | information field 802 | field 803 |
| 133.02.342.553. | time stamp: #304 | the amount of time of |
| calorie consumption: | | exercise: 1 hour |
| 150 kcal | | |

As shown in Table 2, the aggregation unit may cause PHD standard data, whose synchronization information, for example, is a time stamp #304, to correspond to a transmission signal shown in Table 2, and then manage, in pairs, the PHD standard data and the transmission signal. Accordingly, when the PHD standard data, for example, is a blood glucose level of 80 mg/dl, a device using the synchronized information can verify that a blood glucose level of the user is 80 mg/dl after an energy of 150 kcal is consumed during one hour of exercise.

FIG. 9 is a signal flow diagram illustrating a system including a terminal 900 and a server 950 according to another embodiment of the present invention.

As illustrated in FIG. 9, the terminal 900 directly or indirectly collects PHD standard data through a first sensor, in step S901. After collecting the PHD standard data, the terminal 900 acquires synchronization information from the PHD standard data, in step S902. The synchronization information may be a time stamp or a session identification of the PHD standard data, as described above. The terminal 900 acquires additional information, in step S903. As described above, the additional information may include at least one of PHD non-standard data that has been sensed by a second sensor and the like or has been input, and a user input signal that has been input to an interface unit. In accordance with alternative embodiments of the present invention, step S903 may be performed before, during, and/or after steps S901 and S902.

After acquiring the synchronization information and the additional information, the terminal 900 generates a transmission signal including the synchronization information and the additional information, according to a preset standard, in step S904. The terminal 900 detects an event where the transmission signal has been generated, and may notify a server 950 that the transmission signal has been generated, in step S905.

Upon being notified that the transmission signal has been generated, the server 550 may request the transmission of the PHD standard data and the transmission signal, in step S906. Meanwhile, the notification of the server 950 the subsequent request for the transmission of the transmission signal is provided as a non-limiting example according to an embodiment of the present invention. Alternatively, the server 950 may generate an inquiry packet, which periodically inquires whether the transmission signal has been generated, and then transmit the generated inquiry packet to the terminal 900. Upon receiving a response packet corresponding to the inquiry packet, the server 950 may request the terminal 900 to transmit the transmission signal. Alternatively, the server 950 may periodically and unilaterally request the transmission of the PHD standard data and the transmission signal.

Upon receiving the request for the PHD standard data and the transmission signal from the server 950, the terminal 900 may transmit the PHD standard data and the generated transmission signal to the server 950 (S907). However, the above configuration is also merely provided as an example according to an embodiment of the present invention, and, according to alternative embodiments of the present invention, the terminal 900 may immediately and unilaterally transmit the PHD standard data and the transmission signal to the server 950 whenever the terminal 900 detects an event where the transmission signal has been generated. Otherwise, after storing PHD standard data and a transmission signal in an additionally included buffer for a predetermined time period, the terminal 900 may periodically transmit the PHD standard data and the transmission signal to the server 950.

The server 950 extracts synchronization information from the received transmission signal, in step S908. The server 950 compares synchronization information, which has been extracted from the transmission signal, with synchronization information of the PHD standard data. By the comparison, the server 950 may synchronize the PHD standard data with respect to the transmission signal, and then manage the PHD standard data and the transmission signal in pairs, in step S909.

As described above, although the present invention has been shown and described with reference to embodiments thereof, any person having ordinary knowledge in a technical field, to which the present invention is pertained, may make various changes in form and details in embodiments of the present invention without departing a technical idea and scope of the present invention. Accordingly, the spirit and scope of the present invention should be defined not by the described embodiments thereof but by the appended claims and equivalents of the appended claims.

What is claimed is:

1. A terminal comprising:
a first sensor for sensing a biological signal, and outputting Personal Health Device (PHD) standard data that is in accordance with predetermined PHD standards;
at least one second sensor for sensing a biological signal, and outputting PHD non-standard data that is not in accordance with the predetermined PHD standards;
a controller for generating a first data field area based on the PHD standard data, generating a second data field area based on the PHD non-standard data, and generating a transmission signal including the generated first data field area and the generated second data field area; and
a communication unit for receiving the transmission signal from the controller, and transmitting the received transmission signal.

2. The terminal as claimed in claim 1, further comprising a user interface unit for receiving a user input signal,
wherein the controller generates the second data field area based on the PHD non-standard data and the user input signal.

3. The terminal as claimed in claim 1, wherein the PHD standard data is data measured by at least one of a pulse oximeter, a heart rate monitor, a blood pressure monitor, a thermometer, a weighing scale, a blood glucose monitor, a cardiovascular fitness and activity monitor, a strength fitness equipment, a disease management device, an independent living activity hub, and a medication monitor.

4. The terminal as claimed in claim 1, wherein the PHD non-standard data includes information indicating at least one of a type of the second sensor, a type of the PHD non-standard data, a measurement duration, and a measured value of the PHD non-standard data.

5. The terminal as claimed in claim 1, wherein the controller generates the first data field by using a PHD message template.

6. A terminal comprising:
an interface unit for receiving personal health device (PHD) standard data that is in accordance with predetermined PHD standards, and PHD non-standard data that is not in accordance with the predetermined PHD standards;
a controller for generating a first data field area based on the PHD standard data, generating a second data field area based on the PHD non-standard data, and then generating a transmission signal including the first data field area and the second data field area; and
a communication unit for receiving the transmission signal from the controller, and transmitting the received transmission signal.

7. The terminal as claimed in claim 6, wherein the interface unit includes:
a first sub-interface unit for receiving the PHD standard data; and
a second sub-interface unit for receiving the PHD non-standard data, the second sub-interface including a third sub-interface unit for receiving a user input signal,
and wherein the controller generates the second data field area based on the PHD non-standard data and the user input signal.

8. The terminal as claimed in claim 6, wherein the interface unit receives the PHD standard data in a PHD standard communication scheme, and receives the PHD non-standard data according to a predefined communication protocol.

9. The terminal as claimed in claim 1, wherein at least one of the first sensor and the second sensor is external to a main body of the terminal and is connected to the main body of the terminal through at least one of a wired and a wireless connection.

10. The terminal as claimed in claim 9, further comprising an interface unit from receiving output from the at least one of the first sensor and second sensor located external to the main body of the terminal and providing the received output to the controller.

11. A terminal comprising:
a first sensor for sensing a biological signal, and outputting Personal Health Device (PHD) standard data that is in accordance with predetermined PHD standards;
at least one second sensor for sensing a biological signal, and outputting PHD non-standard data that is not in accordance with the predetermined PHD standards;
a controller for extracting synchronization information performing for synchronization between the PHD standard data and the PHD non-standard data from the PHD standard data, generating a first data field area based on the synchronization information, generating a second data field area based on the PHD non-standard data, and then generating a transmission signal including the generated first data field area and the generated second data field area; and
a communication unit for transmitting the PHD standard data and the transmission signal.

12. The terminal as claimed in claim 11, further comprising a user interface unit for receiving a user input signal,
wherein the controller generates the second data field area based on the PHD non-standard data and the user input signal.

13. The terminal as claimed in claim 11, wherein the PHD standard data is data measured by at least one of a pulse oximeter, a heart rate monitor, a blood pressure monitor, a thermometer, a weighing scale, a blood glucose monitor, a cardiovascular fitness and activity monitor, a strength fitness equipment, a disease management device, an independent living activity hub, and a medication monitor.

14. The terminal as claimed in claim 11, wherein the PHD non-standard data includes information indicating at least one of a type of the second sensor, a type of the PHD non-standard data, a measurement duration, and a measured value of the PHD non-standard data.

15. The terminal as claimed in claim 11, wherein the synchronization information corresponds to a time stamp or a session identification of the PHD standard data.

16. A server comprising:
a communication unit for receiving Personal Health Device (PHD) standard data and a transmission signal including a first data field area that is based on synchronization information for synchronization between the PHD standard data, which is in accordance with predetermined PHD standards, and PHD non-standard data, which is not in accordance with the predetermined PHD standards, and a second data field area that is based on the PHD non-standard data;
a controller for synchronizing the PHD standard data with the PHD non-standard data based on the synchronization information extracted from the transmission signal; and
an output unit for outputting pairs of the synchronized PHD standard data and PHD non-standard data.

17. The server as claimed in claim 16, wherein the synchronization information corresponds to a time stamp or a session identification of the PHD standard data.

18. The server as claimed in claim 16, wherein the PHD standard data is data measured by at least one of a pulse oximeter, a heart rate monitor, a blood pressure monitor, a thermometer, a weighing scale, a blood glucose monitor, a cardiovascular fitness and activity monitor, a strength fitness equipment, a disease management device, an independent living activity hub, and a medication monitor.

19. The server as claimed in claim 16, wherein the PHD non-standard data includes information indicating at least one of a type of the second sensor, a type of the PHD non-standard data, a measurement duration, a measured value, and additional user input corresponding to the PHD non-standard data.

20. A terminal comprising:
an interface unit for receiving PHD standard data, which is in accordance with predetermined Personal Health Device (PHD) standards, and PHD non-standard data, which is not in accordance with the predetermined PHD standards;
a controller for extracting synchronization information for performing synchronization between the PHD standard data and the PHD non-standard data from the PHD standard data, generating a first data field area based on the synchronization information, generating a second data field area based on the PHD non-standard data, and then generating a transmission signal including the generated first data field area and the generated second data field area; and
a communication unit for transmitting the PHD standard data and the transmission signal.

21. The terminal as claimed in claim 20, which further comprises a user interface unit for receiving a user input signal, and
wherein the controller generates the second data field area based on the PHD non-standard data and the user input signal.

22. The terminal as claimed in claim 20, wherein the PHD non-standard data includes information indicated at least one of a type of the second sensor, a type of the PHD non-standard data, a measurement duration, and a measured value of the PHD non-standard data.

23. A method for controlling a terminal, the method comprising:
receiving personal health device (PHD) standard data, which is in accordance with predetermined PHD standards, and PHD non-standard data that is not in accordance with the predetermined PHD standards; and
generating a first data field area based on the PHD standard data, generating a second data field area based on the PHD non-standard data, and then generating a transmission signal including the generated first data field area and the generated second data field area.

24. The method as claimed in claim 23, wherein the transmission signal is transmitted in response to request received from a server.

25. The method as claimed in claim 23, further comprising receiving a user input signal,
wherein the second data field area included in the generated transmission signal is generated based on the PHD non-standard data and the user input signal.

26. The method as claimed in claim 23, wherein the PHD standard data is data measured by at least one of a pulse oximeter, a heart rate monitor, a blood pressure monitor, a thermometer, a weighing scale, a blood glucose monitor, a cardiovascular fitness and activity monitor, a strength fitness equipment, a disease management device, an independent living activity hub, and a medication monitor.

27. The method as claimed in claim 23, wherein the PHD non-standard data includes information indicating at least one of a type of a non-standard sensing means, a type of the PHD non-standard data, a measurement duration, and a measured value of the PHD non-standard data.

28. The method as claimed in claim 23, wherein the first data field included in the generated transmission signal is generated by using a PHD message template.

29. A method for controlling a terminal, the method comprising:
receiving Personal Health Device (PHD) standard data that is in accordance with predetermined PHD standards, and PHD non-standard data that is not in accordance with the predetermined PHD standards;
extracting synchronization information for performing synchronization between the PHD standard data and the PHD non-standard data; and
generating a first data field area based on the synchronization information, generating a second data field area based on the PHD non-standard data, and then generating a transmission signal including the generated first data field area and the generated second data field area.

30. The method as claimed in claim 29, further comprising transmitting the PHD standard data and the transmission signal in response a request received from a server.

31. The method as claimed in claim 29, further comprising receiving a user input signal,
wherein the second data field area included in the generated transmission signal is generated based on the PHD non-standard data and the user input signal.

32. The method as claimed in claim 39, wherein the synchronization information corresponds to a time stamp or a session identification of the PHD standard data.

33. A method for controlling a server, the method comprising:
receiving Personal Health Device (PHD) standard data and a transmission signal including a first data field area, such that the first data field area is based on synchronization information for synchronization between the PHD standard data that is in accordance with predetermined PHD standards and receiving PHD non-standard data that is not in accordance with the predetermined PHD standards, and a second data field area, that that the second data field area is based on the PHD non-standard data;
synchronizing the PHD standard data with the PHD non-standard data based on the synchronization information extracted from the transmission signal; and
outputting pairs of the synchronized PHD standard data and PHD non-standard data.

34. The method as claimed in claim 33, wherein the synchronization information corresponds to a time stamp or a session identification of the PHD standard data.

35. The method as claimed in claim 33, wherein the PHD non-standard data includes information indicating at least one of a type of a means for measuring PHD non-standard data, a type of the PHD non-standard data, a measurement duration, a measured value, and additional user input corresponding to the PHD non-standard data.
